(19) United States
(12) Patent Application Publication
(10) Pub. No.: US 2022/0340224 A1
(43) Pub. Date: Oct. 27, 2022

(54) METHOD FOR ASCERTAINING A STATE OF OPERATING DYNAMICS OF A BICYCLE

(71) Applicant: Robert Bosch GmbH, Stuttgart (DE)

(72) Inventors: David Gabriel, Tuebingen (DE); Daniel Baumgaertner, Tuebingen (DE); Johann Skatulla, Reutlingen (DE); Joseph Reck, Filderstadt (DE); Silas Klug, Magstadt (DE); Jan Schnee, Weil Im Schoenbuch (DE)

(21) Appl. No.: 17/657,412

(22) Filed: Mar. 31, 2022

(30) Foreign Application Priority Data
Apr. 14, 2021 (DE) 10 2021 203 686.4

(51) Int. Cl. B62J 45/414; G01P 15/08; G01P 13/00; B62J 45/412

(52) U.S. Cl. CPC B62J 45/414; G01P 15/08; G01P 13/00; B62J 45/412

(57) ABSTRACT

A method for ascertaining a state of operating dynamics of a bicycle. The method includes: providing signals regarding an acceleration in at least one spatial direction and regarding a rate of rotation about at least one spatial direction, with the aid of an inertial measuring device; providing speed signals of an incremental encoder; and ascertaining the state of operating dynamics on the basis of an estimation method, in light of the provided signals; the current riding state being ascertained, and in the case of a dead stop of the bicycle as a current, ascertained riding state, substitute speed signals being provided in place of the speed signals of the incremental encoder, in order to estimate the state of operating dynamics for the estimation method.

### CROSS REFERENCE

The present application claims the benefit under 35 U.S.C. § 119 of German Patent Application No. DE 10 2021 203 686.4 filed on Apr. 14, 2021, which is expressly incorporated herein by reference in its entirety.

### FIELD

The present invention relates to a method for ascertaining a state of operating dynamics of a bicycle, the method including the steps
providing signals regarding an acceleration in at least one spatial direction and regarding a rate of rotation about at least one spatial direction, with the aid of an inertial measuring device;
providing speed signals of an incremental encoder; and
ascertaining the state of operating dynamics on the basis of an estimation method, in light of the provided signals.

The present invention further relates to a device for ascertaining a state of operating dynamics of a bicycle, including an inertial measuring device configured to provide signals regarding an acceleration in at least one spatial direction and regarding a rate of rotation about at least one spatial direction, an incremental encoder configured to provide speed signals, and a state determination device configured to ascertain the state of operating dynamics on the basis of an estimation method, in light of the supplied signals.

The present invention further relates to a bicycle.

Although applicable to any estimation methods, the present invention is described with regard to estimation methods utilizing Kalman filters.

Although applicable to any bicycles, in particular, e-bikes, pedelecs, motorcycles, and the like, the present invention is described with regard to e-bikes.

### BACKGROUND INFORMATION

Important variables, which describe the dynamic response and/or state of operating dynamics of an e-bike, include, inter alia, the speed variable or also the roll angle variable, which represents the lateral inclination of the bicycle. On one hand, this allows different functions of the e-bike to be improved; on the other hand, some functions are only possible through exact knowledge of the states of operating dynamics. However, as a rule, these states of operating dynamics are not able to be measured directly, and/or the equipment necessary for measuring the same is, on one hand, too large to install in the e-bike and, on the other hand, overly expensive, as well.

In order to determine a state of operating dynamics, it is conventional, for example, that cameras or GPS, inertial sensor systems, or also speed sensors may be used, and that the data of the sensors may be evaluated; depending on the presence of corresponding sensors, high-resolution signals of the sensors being necessary, which are, in turn, expensive.

### SUMMARY

In one specific example embodiment, the present invention provides a method for ascertaining a state of operating dynamics of a bicycle, including the steps
providing signals regarding an acceleration in at least one spatial direction and regarding a rate of rotation about at least one spatial direction, with the aid of an inertial measuring device;
providing speed signals of an incremental encoder; and
ascertaining the state of operating dynamics on the basis of an estimation method, in light of the provided signals;
   the current riding state being ascertained, and in the case of a dead stop of the bicycle as a current, ascertained riding state, substitute speed signals being provided in place of the speed signals of the incremental encoder, in order to estimate the state of operating dynamics for the estimation method.

In a further specific example embodiment, the present invention provides a device for ascertaining a state of operating dynamics of a bicycle, including an inertial measuring device configured to provide signals regarding an acceleration in at least one spatial direction and regarding a rate of rotation about at least one spatial direction, an incremental encoder configured to provide speed signals, and a state determination device configured to ascertain the state of operating dynamics on the basis of an estimation method, in light of the provided signals; the current riding state being ascertained, and in the case of a dead stop of the bicycle as a current, ascertained riding state, substitute speed signals being used in place of the speed signals of the incremental encoder, in order to estimate the state of operating dynamics for the estimation method.

In a further specific example embodiment, the present invention provides a bicycle including a device disclosed herein.

One of the advantages consequently possible is that precise estimation of the states of operating dynamics of the bicycle is enabled in every riding state, in particular, at both high and low speeds, on inclines, etc. A further advantage is that drift of the estimate of the speed is prevented, in particular, at a dead stop and/or at very low speeds. By supplying substitute speed signals, the state of operating dynamics may continue to be determined reliably and accurately. In this manner, use of a different estimation method during a dead stop is obviated. One further advantage is that during the transition from a dead stop to a riding state having a positive speed, reliable determination of the state of operating dynamics is likewise enabled, since it is not necessary to correct the drifted, estimated speed signal because of the provision of the substitute speed signals.

The term “bicycle” is to be understood in the broadest sense, and, in particular, in the description, relates to bicycles having at least two wheels, which may be operated manually and/or with the aid of a drive unit. In particular, e-bikes, pedelecs, and motorcycles are to be understood by the term “bicycle.”

Further features, advantages and additional specific embodiments of the present invention are described in the following or become apparent from it.

According to an advantageous further refinement of the present invention, the state of operating dynamics is ascertained with the aid of at least one of the variables displacement, yaw rate, roll angle, and/or pitch angle, as well as a first derivative of the specific variable with respect to time. This allows the specific state of operating dynamics to be determined in a reliable and sufficiently accurate manner.

According to a further advantageous refinement of the present invention, a second derivative of the specific variable with respect to time is additionally ascertained for estimating the state of operating dynamics. One of the advantages rendered possible by that is a more accurate determination of states of operating dynamics.

According to another advantageous further refinement of the present invention, possible changes in the variables, in particular, their second derivative with respect to time, are taken into consideration, using additional noise terms, in order to estimate the state of operating dynamics. Consequently, inaccuracies in the modeling and/or during the determination of the state of operating dynamics may be taken into account in a simple manner.

According to another advantageous further refinement of the present invention, the dead stop of the bicycle is determined with the aid of
a variance of acceleration signals below a predefined value; and/or
a variance of rate-of-rotation signals below a predefined value; and/or
a rider torque above a predefined value and a rider cadence below a predefined value.

This renders a determination and/or detection of a dead stop possible in a simple and simultaneously reliable manner.

According to another advantageous further refinement of the present invention, the estimation method includes the use of a Kalman filter, in particular, a nonlinear Kalman filter. An advantage of this is a sufficient accuracy of the estimate, while the required computational resources are simultaneously justifiable.

According to another advantageous further refinement of the present invention, the incremental encoder is provided in the form of a monopulse incremental encoder including, in particular, a reed contact and/or a rim magnet on a wheel of the bicycle. An advantage of this is a simple and inexpensive incremental encoder.

According to another advantageous further refinement of the present invention, in the estimation method, the state of operating dynamics is estimated with the aid of a model, and in the case of changed, measured values, the estimated state of operating dynamics is adjusted in light of the signals. This renders a reliable and accurate estimate of the state of operating dynamics possible.

According to another advantageous further refinement of the present invention, the state of operating dynamics is ascertained with the aid of at least one sensor-specific parameter of a sensor, in particular, the offset of the sensor and/or position of the sensor on the vehicle. Consequently, an even more accurate determination of the riding state is possible.

According to another advantageous further refinement of the present invention, a lateral and/or vertical speed of a rear wheel of the bicycle is neglected in the determination of the current riding state. An advantage of this is a simpler and more rapid determination of the state of operating dynamics.

Additional, important features and advantages of the present invention are disclosed herein or are derived therefrom in view of the disclosure.

It is understood that the features mentioned above and still to be explained below may be used not only in the respectively indicated combination, but also in other combinations, or by themselves, without departing from the scope of the present invention.

Preferred variants and specific embodiments of the present invention are shown in the figures and are explained in more detail in the following description, where identical reference numerals denote the same or similar or functionally identical components or elements.

### BRIEF DESCRIPTION OF THE DRAWINGS

FIGS. 1A and 1B show comparisons of estimated values and reference values of different dynamic operating state variables, as well as their estimation errors, ascertained by a method according to a specific embodiment of the present invention.

FIG. 2 shows a speed of a bicycle in view of reference values, estimated values, and estimated values using substitute speed signals; the speed being ascertained by a method according to a specific embodiment of the present invention.

FIG. 3 show steps of a method for ascertaining a state of operating dynamics of a bicycle according to a specific embodiment of the present invention.

### DETAILED DESCRIPTION OF EXAMPLE EMBODIMENT

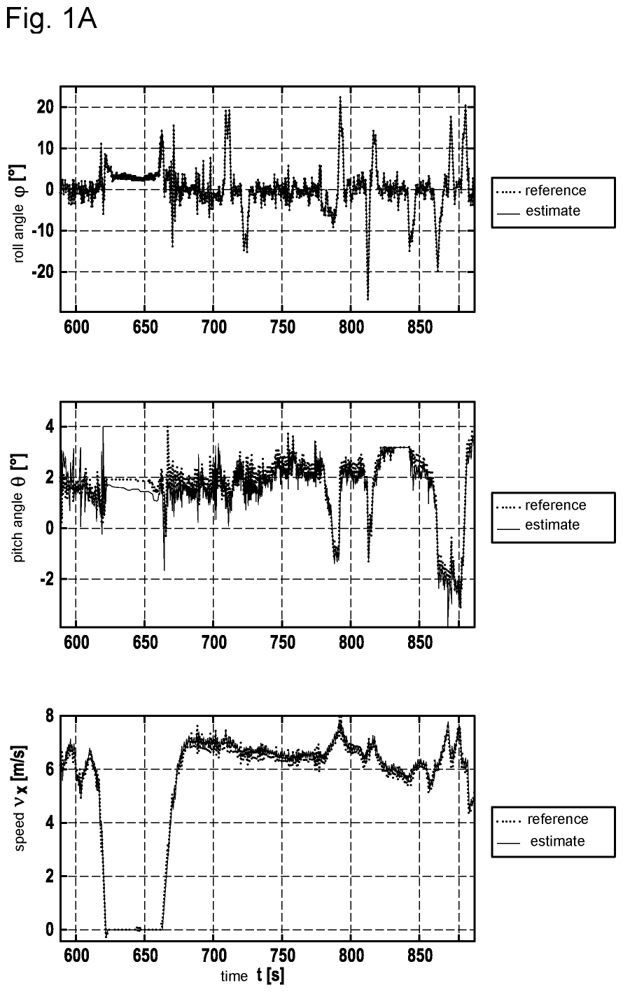

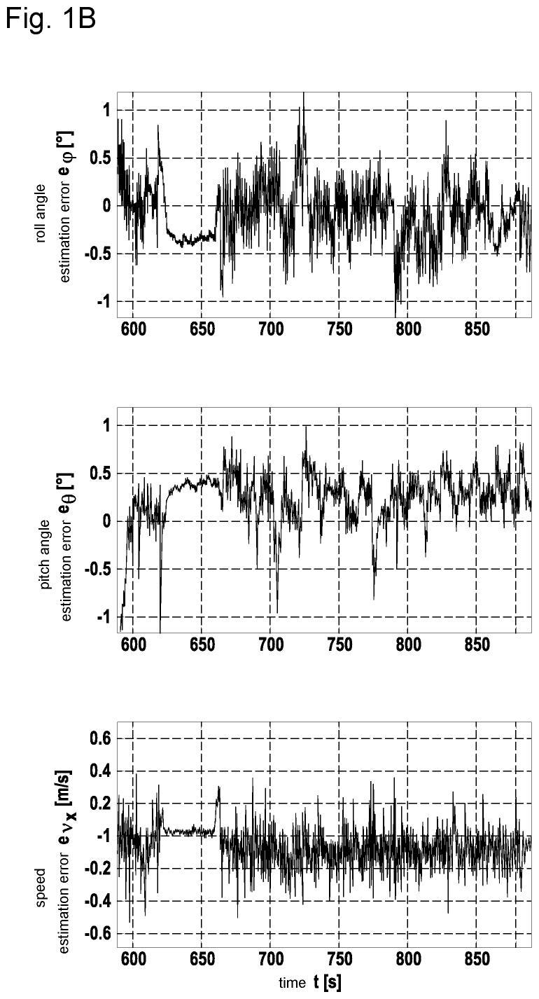

FIGS. 1A and 1B show comparisons of estimated values and reference values of different dynamic operating state variables, as well as their estimation errors, ascertained by a method according to a specific embodiment of the present invention.

In FIGS. 1A and 1B, the dynamic operation variables roll angle, pitch angle, and speed are separately plotted from the top to the bottom, respectively, over a particular time window. In this connection, in FIG. 1A, in each instance, reference values and estimated values of the corresponding variable are plotted in a graphical representation. In FIG. 1B, the specific, estimated, absolute error of the respective variable is plotted.

The high level of agreement of the estimated values of each variable with the reference values, as well as the low, respective, absolute error of the estimated variable, are readily apparent.

In this case, the estimation method for estimating the state of operating dynamics of a bicycle having a front and rear wheel is based on a nonlinear Kalman filter including state limitations for use with a bicycle. In this connection, the estimation method uses information about the current riding state, in particular, “moving” or “stopped,” in order to add pseudo-measurements of the speed, that is, substitute speed signals, during stoppage, and thus, to prevent drift of the speed signal at a dead stop. No signals of the incremental encoder are generated during stoppage, which may result in drift of the estimated speed. By adding the pseudo-measurements or substitute speed signals, it is possible to continue determining all of the states of the bicycle; in particular, a second Kalman filter does not have to be used. This also eliminates the need for a switchover between Kalman filters.

In particular, in a Kalman filter, the state vector for the state of operating dynamics is estimated in a prediction step with the aid of a system model. If new measured values are available, the estimated state is subsequently corrected with the aid of a measuring model and the available measured values. For accurate estimation of, for example, the states of speed, roll angle, pitch angle, and yaw rate, further states, which occur in the exact measuring model, must also be estimated. The vector of the estimated states is put together as follows:

$$x = ( \begin{matrix}s \\ {v}_{x} \\ {a}_{x} \\ \dot{ψ} \\ \ddot{ψ} \\ φ \\ \dot{φ} \\ \ddot{φ} \\ θ \\ \dot{θ} \\ \ddot{θ}\end{matrix} )$$

In this connection, the distance covered by the contact point of the rear wheel is s, the speed of the rear-wheel contact point in the direction of the bicycle is vₓ (corresponds to the bicycle speed), the acceleration of the rear-wheel contact point in the direction of the bicycle is aₓ, the yaw rate is \dot{ψ}, the yaw acceleration is \ddot{ψ}, the roll angle is φ, the roll rate is \dot{φ}, the roll acceleration is \ddot{φ}, the pitch angle is θ, the pitch rate is \dot{θ}, and the pitch acceleration is \ddot{θ}.

This state vector may even be expanded by further states, such as sensor offsets or system parameters, in this case, for example, the position of an inertial measuring unit for measuring acceleration and rate of rotation, if these are also intended to be estimated.

In the following, the order of rotation is yaw-roll-pitch, the inertial system is a north-east-down system, the bicycle system has its origin at the hub of the rear wheel, the x-axis of the bicycle system points in the direction of travel, the y-axis points to the right, and the z-axis points downwards.

Now, the continuous system model of the Kalman filter is as follows:

$$\dot{x} = ( \begin{matrix}{v}_{x} \\ {a}_{x} \\ 0 + {w}_{a} \\ \ddot{ψ} \\ 0 + {w}_{{ψ}^{\cdot \cdot }} \\ \dot{φ} \\ \ddot{φ} \\ 0 + {w}_{{φ}^{\cdot \cdot }} \\ \dot{θ} \\ \ddot{θ} \\ 0 + {w}_{\ddot{θ}}\end{matrix} )$$

In this connection, wₐ, w_{\ddot{ψ}}, w_{\ddot{φ}}, and w_{\ddot{θ}} describe noise terms in the model for the different accelerations. The noise terms are used for taking inaccuracies in the modelling of the system into account. The accelerations are modeled as if they would not change, the noise term allows a change within certain limits.

In order to be able to use the system model for the prediction step of the Kalman filter, it is discretized with the aid of conventional methods.

Measuring models of the different sensors are utilized for the correction step of the Kalman filter.

The following measuring model is obtained for the reed sensor:

θ_{R}=−s/r_{R}−θ

where r_{R} is the radius of the rear wheel, and θ_{R} is the angle of rotation of the rear wheel. This angle of rotation of the rear wheel is updated, when a new reed pulse (and/or another pulse) is available:

θ_{R,new}=θ_{R,last Pulse}+2π

The measuring model of the rate-of-rotation sensor is as follows:

$${ω}_{IMU} = ( \begin{matrix}\dot{φ} cos ( θ ) - \ddot{ψ} cos ( φ ) sin ( θ ) \\ \dot{θ} + ψsin ( φ ) \\ \dot{φ} sin ( θ ) + \dot{ψ} cos ( φ ) cos ( θ )\end{matrix} )$$

The state limitations of the bicycle have an influence on the measuring model of the acceleration sensor. In this context, it is assumed, in particular, that the rear wheel has no lateral slip, that is, the lateral speed of the rear-wheel contact point v_{y}=0.

To derive the measuring model of the acceleration sensor, the position of the inertial measuring unit in the bicycle coordinate system and in the inertial/world coordinate system is initially determined. In this context, in the following, the z-dynamics and the accompanying change in the z-coordinate in the inertial/world coordinate system of the bicycle are neglected.

$${p}_{IMU , bicycle system} = ( \begin{matrix}{x}_{IMU} \\ {y}_{IMU} \\ {z}_{IMU}\end{matrix} ) \\ {p}_{IMU , inertial system} = ( \begin{matrix}x - {r}_{R} sin φ sin ψ \\ y + {r}_{R} cos ψ sin φ \\ - {r}_{R} cos φ\end{matrix} ) + R ( \begin{matrix}{x}_{IMU} \\ {y}_{IMU} \\ {z}_{IMU}\end{matrix} )$$

The distances x_{IMU}, y_{IMU} and z_{IMU} between the rear-wheel hub and the inertial measuring unit are fixed, x and y are the coordinates of the rear-wheel contact point in the inertial system. R is the rotation matrix, which describes the position of the bicycle in space.

The speed of the inertial measuring unit is obtained by differentiating the position of the inertial measuring unit with respect to time:

$${v}_{IMU , inertial system} = \frac{{dp}_{IMU , inertial system}}{dt}$$

In this, \dot{x} and \dot{y} (speeds of the rear-wheel contact point) are replaced by

$$( \begin{matrix}\dot{x} \\ \dot{y}\end{matrix} ) = ( \begin{matrix}cos ψ & sin ψ \\ - sin ψ & cos ψ\end{matrix} ) ( \begin{matrix}{v}_{x} \\ {v}_{y}\end{matrix} )$$

Since, as explained above, it is assumed that there is no slip of the rear wheel, the lateral speed is set to zero (v_{y}=0). By further differentiating with respect to time, the acceleration of the sensor in world coordinates is obtained.

$${a}_{IMU , inertial system} = \frac{{dv}_{IMU , inertial system}}{dt}$$

In order to obtain the measuring model for the acceleration sensor, gravitational acceleration g is taken into account, and with the aid of rotation matrix R, which describes the position of the bicycle, the accelerations are rotated into the sensor coordinate system:

$${a}_{IMU} = {R}^{T} ( {a}_{IMU , inertial system} - ( \begin{matrix}0 \\ 0 \\ g\end{matrix} ) )$$

The measuring equation of the acceleration sensor is independent of the coordinates of the rear-wheel contact point (x, y) and of yaw angle ψ and may therefore be represented by the states described above. The specific measurements and measuring models are only used for the correction step, if new information is present in the corresponding sensor.

In order to prevent drift of the speed signal at a dead stop, when no more pulses of the incremental encoder occur, the dead stop must initially be detected. One or more of the following options may be used for this:
Low variance of the acceleration signals→there is no motion/vibrations due to the travel of the bicycle.
Low variance of the rate-of-rotation signal→there is no motion of the bicycle.
The present rider torque, rider cadence=0→when the brake is held, the foot of the rider resides on the pedal, the bicycle is stopped.

If a dead stop is detected, then a pseudo-measurement of the speed and/or substitute speed signals are transmitted to the Kalman filter. This results in the estimated speed signal approaching zero at a dead stop.

The corresponding measuring model is:

\dot{θ}_{R}=−vₓ/r_{R}−\dot{θ}

In one further specific embodiment, the state vector may be reduced by three states, by neglecting angular accelerations \ddot{ψ}, \ddot{φ}, and \ddot{θ} in the measuring equation of the acceleration sensor. Then, the system model is correspondingly adjusted, using “constant rates of rotation” instead of “constant angular accelerations.” This leads to improved efficiency of the estimation method.

In one further specific embodiment, the z-dynamics of the bicycle may additionally be considered. In this connection, in particular, the assumption is made that the rear wheel of the bicycle is constantly in contact with the roadway, that is, does not become airborne. Accordingly, it is assumed that the vertical speed of the rear-wheel contact point is zero (v_{z}=0). This assumption has an influence on the derivation of the acceleration measuring equation a_{IMU}. In addition, the grade of the roadway and/or the pitch angle of the bicycle is further taken into account in the conversion of the speeds from inertial/world coordinates to bicycle coordinates.

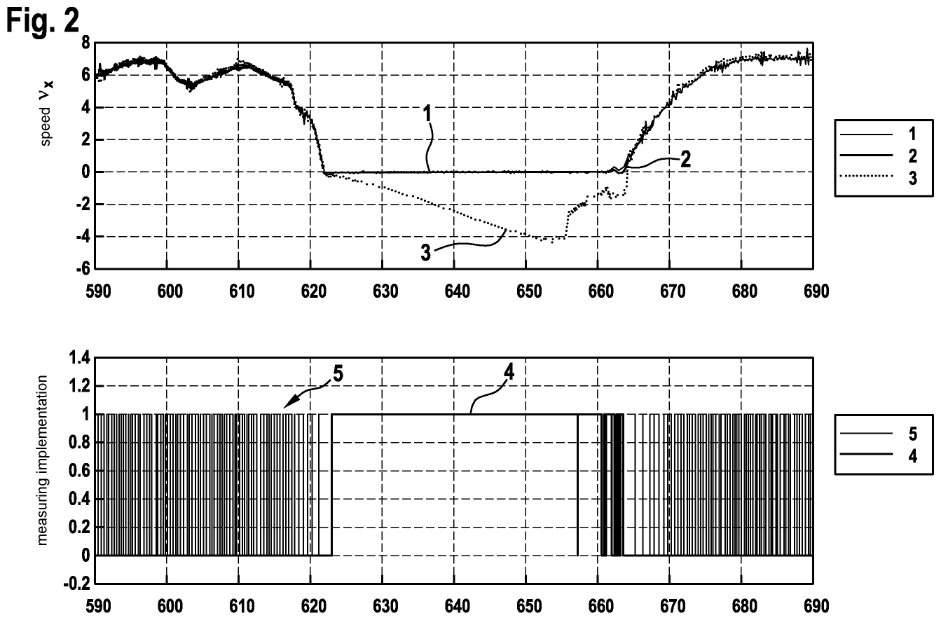

As described, FIGS. 1A and 1B show a comparison of estimated states and reference values. The effect of the pseudo-measurements during stoppage is shown in the following FIG. 2.

FIG. 2 shows a speed of a bicycle in view of reference values, estimated values, and values estimate using substitute speed signals; the speed being ascertained by a method according to a specific embodiment of the present invention.

Reference values 1 and estimates 2, 3 of the speed over a time window are plotted in FIG. 2; the latter being plotted once with substitute speed signals (curve 2) and once without substitute speed signals (curve 3). At the bottom of FIG. 2, reed pulses 5 are plotted over the corresponding time window; no reed pulses 5 occurring in the range of approximately 623 s to 667 s, and therefore, a substitute speed pulse 4 being provided. In other words, in this range, the bicycle is stopped, and the reed sensor does not supply any more speed signals. It is clearly apparent that the estimated state of operating dynamics is more accurate in the case of use of substitute speed signals, and that drift of the estimated state of operating dynamics is prevented.

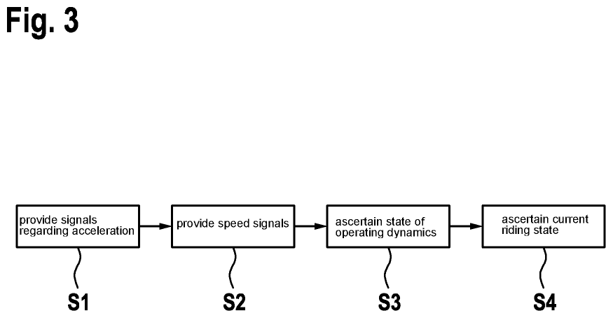

FIG. 3 shows steps of a method for ascertaining a state of operating dynamics of a bicycle according to a specific embodiment of the present invention.

In detail, FIG. 3 shows steps of a method for ascertaining a state of operating dynamics of a bicycle.

In this context, the method includes the steps
providing S1 signals regarding an acceleration in at least one spatial direction and regarding a rate of rotation about at least one spatial direction, with the aid of an inertial measuring device;
providing S2 speed signals of an incremental encoder; and
ascertaining S3 the state of operating dynamics on the basis of an estimation method, in light of the supplied signals;
   the current riding state S4 being ascertained, and in the case of a dead stop of the bicycle as a current, ascertained riding state, substitute speed signals being provided in place of the speed signals of the incremental encoder, in order to estimate the state of operating dynamics for the estimation method.

In summary, at least one of the specific embodiments of the present invention includes at least one of the following features and/or provides at least one of the following advantages:
Simple, reliable and accurate determination of the state of operating dynamics of a bicycle.
Drift of the estimate of the speed is prevented.

Although the present invention was described in light of preferred exemplary embodiments, it is not limited to them, but is modifiable in numerous ways.

What is claimed is:

1. A method for ascertaining a state of operating dynamics of a bicycle, the method comprising the following steps:
providing signals regarding an acceleration in at least one spatial direction and regarding a rate of rotation about at least one spatial direction, using an inertial measuring device;
providing speed signals of an incremental encoder;
ascertaining the state of operating dynamics on the basis of an estimation method, in light of the supplied signals;
ascertaining a current riding state of the bicycle, wherein;
based on the current riding state of the bicycle being ascertained as a dead stop of the bicycle, providing substitute speed signals in place of the speed signals of the incremental encoder, to estimate the state of operating dynamics for the estimation method.

2. The method as recited in claim 1, wherein the state of operating dynamics is ascertained using at least one of the variables: displacement, and/or yaw rate, and/or roll angle, and/or pitch angle, and a first derivative of the at least one of the variables with respect to time.

3. The method as recited in claim 2, wherein a second derivative of the at least one of the variables with respect to time is additionally ascertained for estimating the state of operating dynamics.

4. The method as recited in claim 2, wherein to estimate the state of operating dynamics, a possible change in the at least one of the variables, including their second derivative with respect to time, is taken into account, using additional noise terms.

5. The method as recited in claim 1, wherein a dead stop of the bicycle is ascertained using:
a variance of acceleration signals below a predefined value; and/or
a variance of rate-of-rotation signals below a predefined value; and/or
a rider torque above a predefined value and a rider cadence below a predefined value.

6. The method as recited in claim 1, wherein the estimation method includes use of a Kalman filter.

7. The method as recited in claim 6, wherein the estimation method includes use of a nonlinear Kalman filter.

8. The method as recited in claim 1, wherein the incremental encoder is a monopulse incremental encoder including a reed contact and/or a rim magnet on a wheel of the bicycle.

9. The method as recited in claim 1, wherein in the estimation method, the state of operating dynamics is estimated using a model, and in the case of changed, measured values, the estimated operating dynamics state is adjusted in light of the signals.

10. The method as recited in claim 1, wherein the state of operating dynamics is ascertained using at least one sensor-specific parameter of a sensor, including an offset of the sensor and/or position of the sensor on the vehicle.

11. The method as recited in claim 1, wherein a lateral and/or vertical speed of a rear wheel of the bicycle is neglected in the ascertaining of the current riding state.

12. A device for ascertaining a state of operating dynamics of a bicycle, comprising:
an inertial measuring device configured to provide signals regarding an acceleration in at least one spatial direction and regarding a rate of rotation about at least one spatial direction;
an incremental encoder configured to provide speed signals; and
a state determination device configured to ascertain the state of operating dynamics based on an estimation method, in light of the provided signals;
wherein the device is configured to ascertain a current riding state of the bicycle, and if the current riding state of the bicycle is ascertained as a dead stop of the bicycle, substitute speed signals are used in place of the speed signals of the incremental encoder, to estimate the state of operating dynamics for the estimation method.

13. A bicycle, comprising:
a device for ascertaining a state of operating dynamics of a bicycle, including:
an inertial measuring device configured to provide signals regarding an acceleration in at least one spatial direction and regarding a rate of rotation about at least one spatial direction;
an incremental encoder configured to provide speed signals; and
a state determination device configured to ascertain the state of operating dynamics based on an estimation method, in light of the provided signals;
wherein the device is configured to ascertain a current riding state of the bicycle, and if the current riding state of the bicycle is ascertained as a dead stop of the bicycle, substitute speed signals are used in place of the speed signals of the incremental encoder, to estimate the state of operating dynamics for the estimation method.
